(19) United States
(12) Patent Application Publication
(10) Pub. No.: US 2015/0059517 A1
(43) Pub. Date: Mar. 5, 2015

(54) UNIVERSAL LAWN SPREADER CONTROL HANDLE EXTENSION KIT

(71) Applicant: Jesse Calloway, Chesterfield, VA (US)

(72) Inventor: Jesse Calloway, Chesterfield, VA (US)

(21) Appl. No.: 14/477,019

(22) Filed: Sep. 4, 2014

Related U.S. Application Data
(60) Provisional application No. 61/873,818, filed on Sep. 4, 2013.

(51) Int. Cl. G05G 7/00

(52) U.S. Cl. CPC G05G 7/00
USPC 74/523

(57) ABSTRACT

A universal lawn spreader control handle extension kit comprising connectors, cables, clamps, brackets, telescoping sleeves, and other components, and enabling extension of the handle of a typical lawn spreader. Such spreaders may be used to apply lawn fertilizer, salt, or other ingredients or granular particulate compatible with such spreader devices. Extensions may be associated with various configurations of lawn spreader handle, herein referred to by the letter they most resemble (e.g. a “T” handle may consist of a single extended strut with two grips extending perpendicularly from the end, while a “U” handle may be a closed loop) and generally limited to the configurations “T,” “U,” “M,” “X,” and “H.” The above referenced configurations may be installed alternatively to achieve extended handle control; extension may result from protracting the original equipment manufacturers' (OEM) handle (such as is the case with configuration “M”), or such extension may be achieved via connection to the OEM handle or other parts of the spreader (in cases where configurations “T,” “U,” “H,” or “X” are employed).

### BACKGROUND

Many devices that are adapted for lawn care feature a wheeled cart as a core part of their design. Wheelbarrows, push mowers, and lawn spreaders traditionally work similarly in that a user stands behind the device and pushes forward on a raised handle to operate the device in its intended environment and for its intended purpose.

However, such activity can often be uncomfortable to a user. Often, users may be forced to bend forward by a number of degrees to work their body into a position where they may readily push the handle of the device, causing momentary or even enduring user discomfort or pain. Even should the handle of the device have been made extensible by the original manufacturer, other features (such as the starter of an electric- or gas-powered device, or any control system that the device may have) are generally fixed in place and may be uncomfortable for a taller user to adjust.

### SUMMARY

According to one exemplary embodiment, a device capable of protracting control of the existing or modified handle of a lawn care device to a length desired by a user may be disclosed. Such a device may supplement the existing handle or may modify or replace it in whole or in part, and a variety of potential handle configurations (such as “T,” “U,” “M,” “X,” and “H”) may be supported. The device may allow a user to set the height of a handle to be a more desirable one and may reduce a user's bend angle, affording the user increased comfort during routine use of the device. The device may include at least one external connector, at least one handle support, at least one push handle, and at least one control device, and may optionally include a stability bar capable of keeping the lawn spreader stable when not in use. The handle support(s), push handle(s), and stability bar(s) may have adjustable lengths. The device may be operationally linked to the lawn spreader's original-equipment-manufacturer-supplied controls, which may require modifying those controls in an appropriate fashion.

### BRIEF DESCRIPTION OF THE FIGURES

FIG. 1 is an exemplary embodiment of a lawn spreader design to which the universal lawn spreader control handle extension may be applied.

FIG. 2 is another exemplary embodiment of a lawn spreader design to which the universal lawn spreader control handle extension may be applied.

2A is another exemplary embodiment of a lawn spreader design to which the universal lawn spreader control handle extension may be applied.

2B is another exemplary embodiment of a lawn spreader design to which the universal lawn spreader control handle extension may be applied.

FIG. 3 is an exemplary embodiment of a universal lawn spreader control handle extension with a “U” configuration.

FIG. 3A is another exemplary embodiment of a universal lawn spreader control handle extension with a “U” configuration.

FIG. 3A1 is another exemplary embodiment of a universal lawn spreader control handle extension with a “U” configuration.'

FIG. 4 is an exemplary embodiment of a universal lawn spreader control handle extension with an “X” configuration.

FIG. 5 is an exemplary embodiment of a universal lawn spreader control handle extension with either a “U” or an “X” configuration.

FIG. 6 is an exemplary embodiment of a universal lawn spreader control handle extension with an “H” configuration.

FIG. 7 is an exemplary embodiment of a universal lawn spreader control handle extension with a “T” configuration.

FIG. 8 is an exemplary embodiment of a universal lawn spreader control handle extension with a “T” configuration.

FIG. 8A is another exemplary embodiment of a universal lawn spreader control handle extension with a “T” configuration.

FIG. 8A1 is another exemplary embodiment of a universal lawn spreader control handle extension with a “T” configuration.

FIG. 8B is another exemplary embodiment of a universal lawn spreader control handle extension with a “T” configuration employing extension sleeves.

FIG. 9 is an exemplary embodiment of a universal lawn spreader control handle extension with an “M” configuration.

FIG. 9A is another exemplary embodiment of a universal lawn spreader control handle extension with an “M” configuration.

FIG. 9A1 is another exemplary embodiment of a universal lawn spreader control handle extension with an “M” configuration

FIG. 10 is an exemplary embodiment of a universal lawn spreader control handle extension with a “U” configuration.

FIG. 11 is an exemplary embodiment of a universal lawn spreader control handle extension, as applied to a lawn spreader device that features a stability bar.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

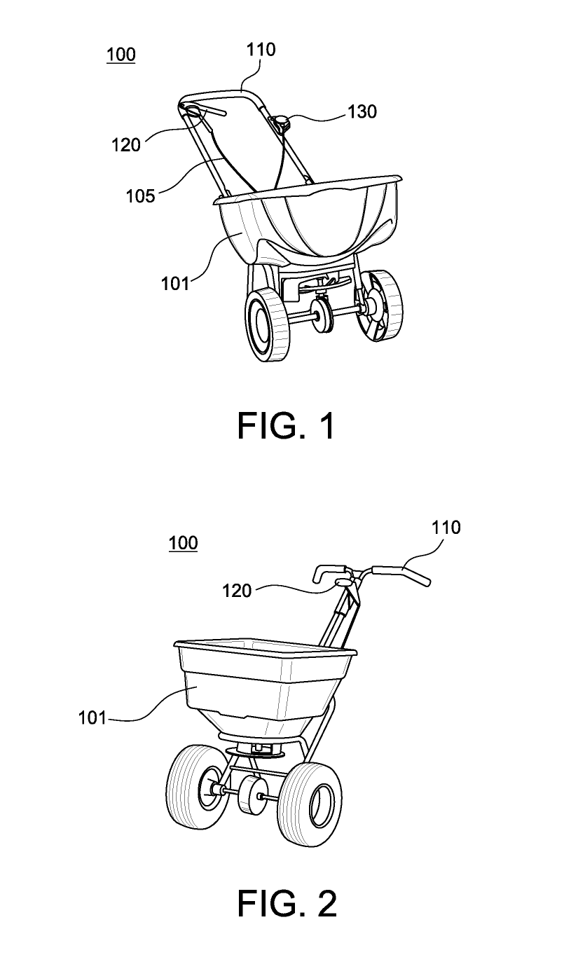

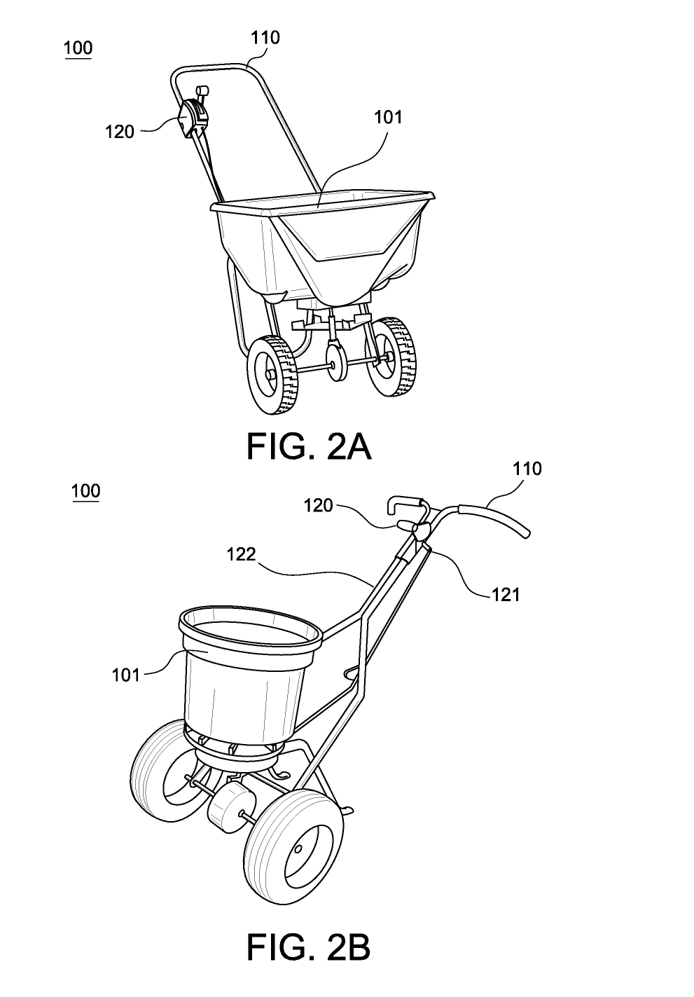

FIGS. 1, 2, 2A, and 2B display exemplary embodiments of lawn spreader designs 100 with which a universal lawn spreader control handle extension may be combined. Hereinafter, “universal lawn spreader control handle extension” may be referred to as a “handle extension.” Additionally, the term “handle extension” is non-limiting and can apply to both those embodiments of the universal lawn spreader control handle extension that may be used to supplement the existing handle of a lawn spreader and those that may be used to modify or replace an existing handle in whole or in part. These designs may have, among other features, original equipment manufacturer-supplied (“OEM”) handles 110 (including a push handle component and a handle support component 122) and OEM discharge control levers 120. Exemplary FIGS. 1 and 2A show embodiments in which the lawn spreader 100 has an OEM handle 110 in a closed-loop “U” configuration and a side-mounted OEM discharge control lever 120, while exemplary FIGS. 2 and 2B display embodiments where the lawn spreader 100 features an OEM handle 110 in a “T” configuration and a centrally-located OEM discharge control lever 120. Exemplary embodiments of handle extensions may themselves have several configurations, which may similarly be referred to by letter (e.g. a “U,” “T,” “X,” “H,” or “M” configuration). These different configurations of handle extensions may have different shapes, and may be compatible with any OEM handle 110 configuration or with only a subset thereof. For example, a particular handle extension may be adapted to lawn spreader designs 100 that feature OEM handles 110 in the “U” configuration, and may not be compatible with lawn spreader designs 100 that feature OEM handles 110 in the “T” configuration.

Lawn spreaders 100 may also include additional OEM control features other than the OEM discharge control lever 120. For example, a lawn spreader design 100 might additionally include at least one settings control 130 that can allow a user to vary the performance of the lawn spreader device 100. For example, a settings control 130 might be a flow control knob or dial that allows a user to select the amount of material dispensed by a manipulation of the discharge control lever 120, enabling the user to dispense relatively consistent amounts of material from the lawn spreader device 100. Alternatively, a settings control device 130 might be a control for an edge protector (e.g. a Scott EdgeGuard®) or a control for a similar device that allows a user to adjust the application area of the lawn spreader 100 or the direction of material dispensed. A handle extension may be compatible with any or all such settings control devices 130. The OEM discharge lever 120 and/or the settings control 130 may be operationally connected to the body of the lawn spreader 101 by way of an OEM cable 121, or as desired.

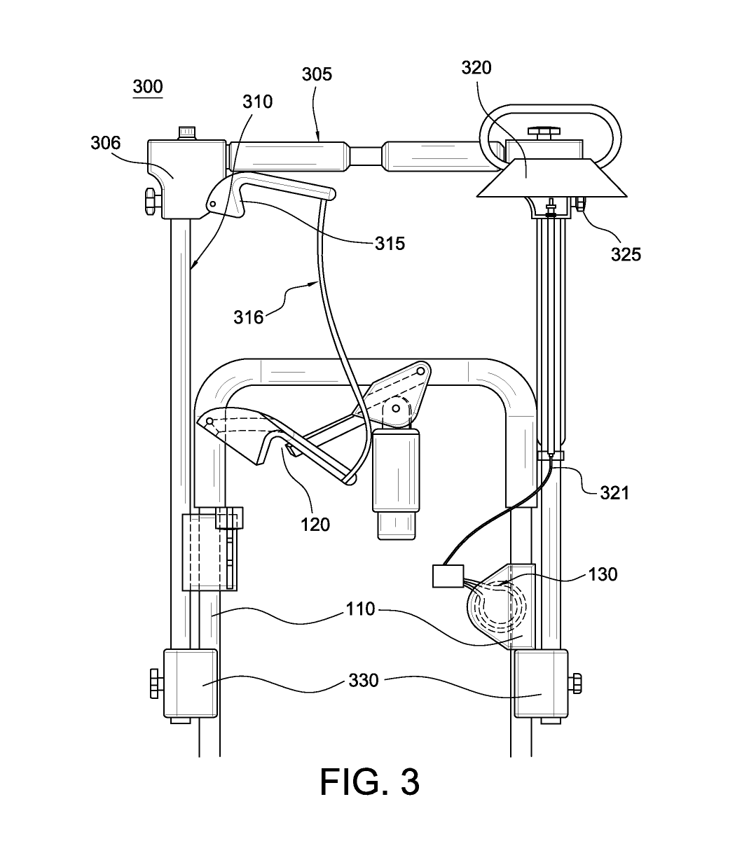

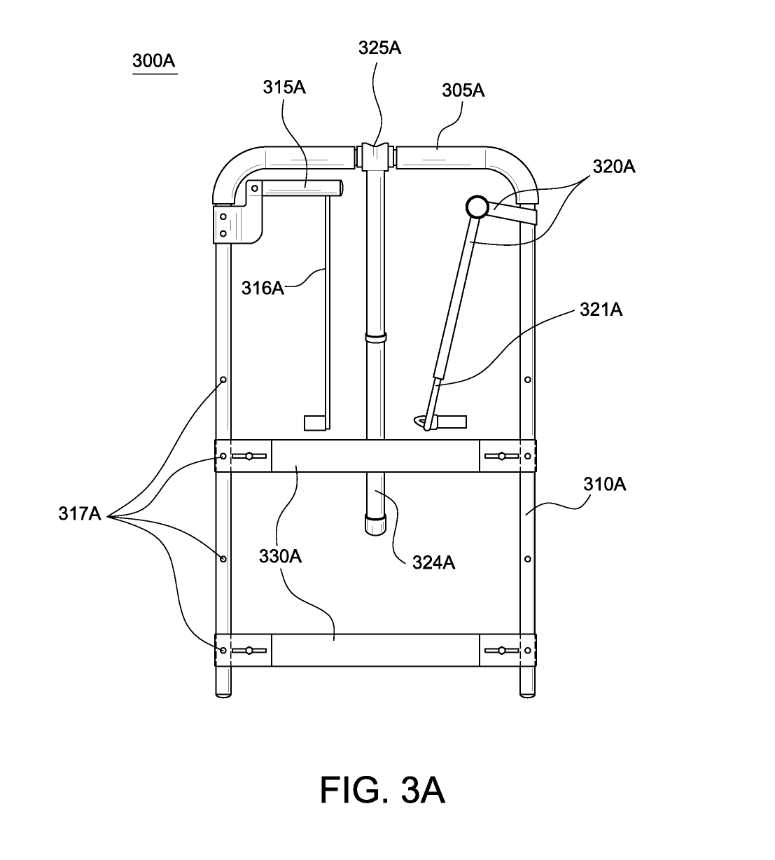

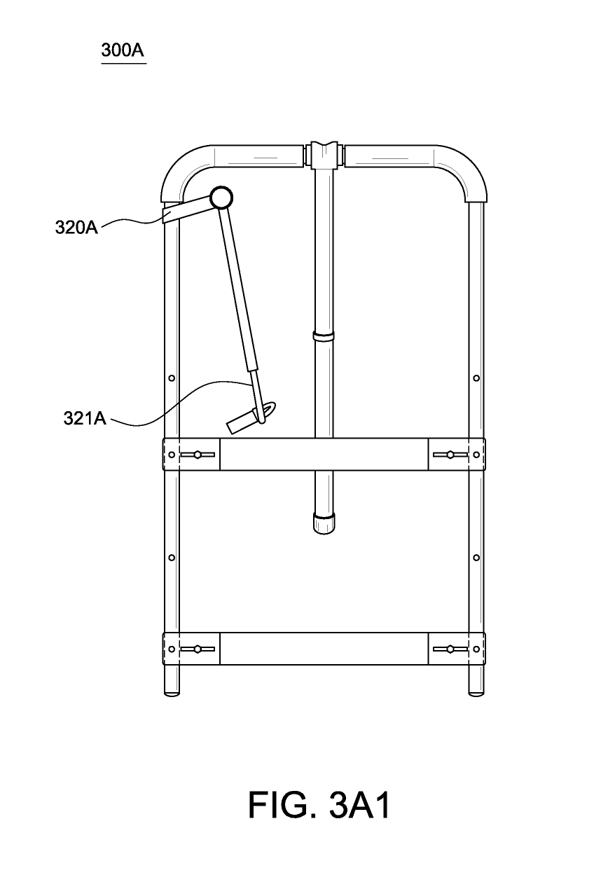

FIG. 3 displays an exemplary embodiment of a handle extension 300. This embodiment of a handle extension is in a “U” configuration, and can have a single continuous push handle 305, two continuous handle supports 310, and a single stability bar or site where a stability bar may be mounted 325. Alternative exemplary embodiments of handle extensions 300 may have different amounts of each of the aforementioned components, for example, according to a configuration or according to the specific characteristics of the lawn spreader devices to which the alternative embodiments are intended to be attached. For example, one alternative embodiment may have any number of stability bars 325 at different locations on the handle extension 300 for additional stability, or may have a stability platform or another stabilizing mechanism. A second exemplary embodiment of a handle extension 300 might be utilized for lawn spreader designs that consistently remain stable even with the handle extension 300 in place, or which include their own stability supports or equivalent designs. Such an exemplary embodiment may not include a stability bar 325. A third alternative embodiment might utilize other lateral supports further down the handle supports 310 that run parallel to the push handle 305, perpendicular to the push handle 305, or at an intermediate angle. A fourth embodiment might feature more than one push handle 305, each of which may extend from the end of a handle support 310, and which may be individually smaller than push handles 305 in other embodiments (i.e. each of the push handles 305 in the fourth embodiment might be sized to accommodate one of a user's hands).

In the exemplary embodiment of FIG. 3, the single push handle 305 may expand or contract in length to allow the handle extension to fit a variety of lawn spreader handles 110; in an alternative exemplary embodiment of a handle extension 300, any or all of the push handles 305, handle supports 310, or stability bars 325 may expand or contract telescopically or may be otherwise extensible or adjustable. For example, one embodiment could allow a user to add or remove spacer inserts to a handle support design until the user determined that the handle support was of the proper length. Expansion or contraction of a component in the handle extension 300 may be facilitated by the component being constructed from a plurality of different parts, at least one of which is generally of a larger size or diameter than the others. Alternatively, parts could be generally the same size or diameter and could be flared where they are to interlock, could be of similar size and could interlock with one or more adjustable sleeves that fit over and linked the ends of a plurality of parts, or could otherwise be designed to interlock or allow expansion or contraction in length. Telescoping or other extensibility or contractibility of the handle supports 310 may be identified as “north-to-south” expansion or contraction of the handle extension 300, while similar behavior from the push handle 305 or any other lateral supports may be identified as “east-to-west” expansion or contraction. The “north” end may identify the end of a handle support 310 that is closest to the user, while the “south” end may identify the end that is furthest from the user and closest to the body of the lawn spreader. Expanding or contracting components of the handle extension 300 may be held to a particular length or locked in place by the use of set screws, snap screws, a friction fit, or any other desirable manner. In the embodiment shown in FIG. 3, the push handle may be secured at a particular width by way of a clamp 306 that a user may tighten or loosen as desired.

The handle extension 300 also may include mounting sites for a discharge control device 315 and a settings control device 320. The mounting site for a discharge control device 315 may include a grip handle or other control device that may be connected to an OEM control device 120 originally mounted on the lawn spreader, may accommodate the relocation of an OEM control device 120 from the lawn spreader to the mounting site 315, or may feature some combination of the two. In the first case, wherein the mounting site 315 includes a discharge control device in the form of a grip handle and wherein the OEM control device 120 is a lever, the grip handle on the mounting site 315 may be operationally connected to the OEM lever 120 by connecting a tie wrap, friction fit cap, or other cable or material 316 to the OEM lever 120 and then to the grip handle, such that when the grip handle was operated by a user the OEM lever 120 would be contracted. In the second case, wherein the mounting site 315 accommodates the relocation of an OEM control device 120, the OEM control device 120 may be removed from its location on the lawn spreader and relocated to the mounting site 315. Depending on the desired length of the handle extension 300, this may require the replacement of the OEM control cable with a longer control cable, or may require the splicing of the OEM control cable with accessory hardware (e.g. split bolts). The mounting site for a settings control device 320 may function similarly; it may allow an OEM settings control device 130 (such as an edge protector extended control device) to be manipulated at a distance using another cable, telescoping linkage, or connector 321, may accommodate the relocation of the OEM settings control device 130 to the handle extension 300 with or without replacement or modification or replacement of the OEM settings control device cable, or as desired.

The embodied handle extension 300 may be linked to the lawn spreader device via connectors 330 located on the handle supports 310. In the preferred embodiment, connectors 330 will be located on or near the ends of the handle supports 310, but are not required to be. According to an alternative exemplary embodiment, additional connectors or brackets may be installed (in the “east-west” direction or otherwise) in lieu of or in addition to connectors 330 for securing and or allowing for “north-south” movement of the push handle 305. Connectors may be of any type; according to the exemplary embodiment displayed in FIG. 3, clamps may be used to secure the handle supports 310 to the lawn spreader device, while according to another, wing nuts, brackets, and/or tie wraps may be used. Multiple instances of the same connector and multiple types of connectors may be used; for example, one exemplary embodiment of a handle extension 300 may use two tie wraps and a c-clamp to secure a handle support 310 to the lawn spreader frame.

FIGS. 3A and 3A1 display an exemplary embodiment of a handle extension 300A. This embodiment of a handle extension is in a “U” configuration, and can have a single continuous push handle 305A, handle supports 310A, and a single stability bar 324A or site where a stability bar may be mounted 325A. Alternative exemplary embodiments of handle extensions 300A may have different amounts of each of the aforementioned components, for example, according to a configuration or according to the specific characteristics of the lawn spreader devices to which the alternative embodiments are intended to be attached. For example, one alternative embodiment may have any number of stability bars 324A at different locations on the handle extension 300A for additional stability, or may have a stability platform or another stabilizing mechanism. A second exemplary embodiment of a handle extension 300A might be utilized for lawn spreader designs that consistently remain stable even with the handle extension 300A in place, or which include their own stability supports or equivalent designs. Such an exemplary embodiment may not include a stability bar mounting area 325A or a stability bar 324A. A third alternative embodiment might include other lateral supports other than the handle supports 310A, such as support struts in the east-to-west or north-to-south directions. A fourth embodiment might utilize multiple push handles 305A.

In the exemplary embodiment of FIG. 3A, the single continuous push handle 305A may be installed on the existing OEM handle using mounting brackets 330A and mounting holes 317A to expand or contract in length to allow the handle extension to fit a variety of lawn spreader handles 110; in an alternative exemplary embodiment of a handle extension 300A, any or all of the handle supports 310A or stability bars 325A may expand or contract telescopically or may be otherwise extensible or adjustable. For example, one embodiment could allow a user to position connectors on brackets 330A such that a variety of lawn spreader handles 110 that vary in size in the east-to-west direction may be accommodated. Expansion or contraction of a component in the handle extension 300A may be facilitated by the component being constructed from a plurality of different parts, at least one of which is generally of a larger size or diameter than the others. Alternatively, parts could be generally the same size or diameter and could be flared where they are to interlock, could be of similar size and could interlock with one or more adjustable sleeves that may fit over and/or otherwise link the ends of a plurality of parts, or could otherwise be designed to interlock or expand or contract in length. Expanding or contracting components of the handle extension 300A may be held to a particular length or locked in place by the use of set screws, snap screws, a friction fit, or any other desirable manner. In the embodiment shown in FIG. 3A, the push handle 305A may be secured at a particular OEM lawn spreader handle width by way of clamps installed on brackets 330A that a user may tighten or loosen and adjust inside the provided mounting holes 317A (herein depicted as horizontal slots) as desired.

The handle extension 300A also may include mounting sites for a discharge control device 315A and a settings control device 320A (such as an edge protector control). The mounting site for a discharge control device 315A may include a grip handle or other control device that may be connected to an OEM control device 120 originally mounted on the lawn spreader, may accommodate the relocation of an OEM control device 120 from the lawn spreader to the mounting site 315A, or may feature some combination of the two. In the first case, wherein the mounting site 315A includes a discharge control device in the form of a grip handle and wherein the OEM control device 120 is a lever, the grip handle on the mounting site 315A may be operationally connected to the OEM lever 120 by connecting a tie wrap, friction fit cap, or other cable or material to the OEM lever 120 and then to the grip handle, such that when the grip handle was operated by a user the OEM lever 120 would be contracted. The mounting site for a settings control device 320A may function similarly; it may allow an OEM settings control device 130 to be manipulated at a distance using another cable, telescoping linkage, or connector 321A, or may allow the OEM settings control device to be relocated. In some embodiments, OEM control devices may not be easily modified without risking damage to the device (for example, an edge protector control may employ a sealed plastic toggle switch that may crack if a user tries to disassemble it); in instances such as these, a temporary or permanent adhesive may be used to operationally connect the OEM control device to a settings control device mounted at the mounting site 320A.

The embodied handle extension 300A may be linked to the lawn spreader device via brackets 330A located on the handle supports 310A. In the preferred embodiment, brackets 330A will be located per distances defined by the pre-drilled holes 317A located on the handle supports 310, but are not required to be. Connectors or brackets may be of any type; according to the exemplary embodiment displayed in FIG. 3A, clamps may be used to secure the handle supports 310A, via connectors and slots installed on brackets 330A, to the lawn spreader device. Multiple instances of the same connector and multiple types of connectors may be used; for example, one exemplary embodiment of a handle extension 300A may use two tie wraps and a c-clamp to secure a handle support 310A to the lawn spreader frame. In order to accommodate installation of the handle 300A to an OEM installed lawn spreader such as that shown in FIG. 2A, which only has a lever type discharge chute control device 120, the extended operation of such control device is accomplished by relocation of linkage configuration 320A and 321A to the side of handle extension 300A that is closest to the OEM installed discharge lever 120.

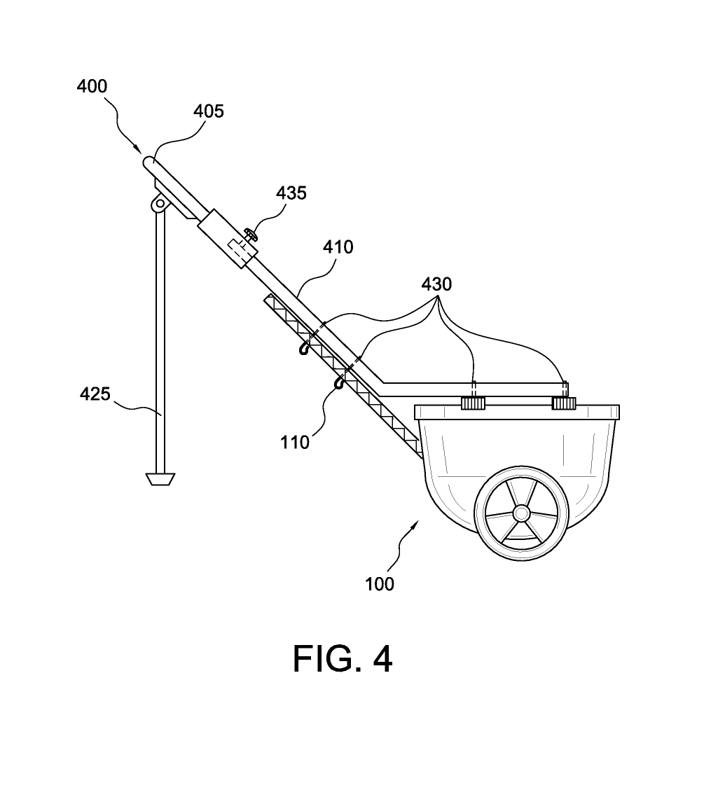

FIG. 4 displays another potential embodiment of a handle extension 400, in this case attached to and in use with a lawn spreader device. This embodiment of a handle extension 400 is in an “X” configuration; in this configuration, the handle extension 400 may attach to the lawn spreader body 100 as well as to the existing handle 110. Such an embodiment may feature at least one of each of: a push handle 405, a handle support 410, and a stability bar 425. The embodied handle extension 400 may be attached to the lawn spreader body by use of connectors 430, which may be mounting brackets, c-clamps, tie wraps, wing nuts, or any other connectors desired.

The handle supports 410, provided that they are telescoping or otherwise extensible, may be set at a particular length via a set screw 435. Alternatively, a bolt, a pin, or another connector or series of connectors may be used. The connector 435 may be fully exposed on the front of the handle extension 400 as in the exemplary figure, may be shrouded or concealed from view, or as desired. The position of the connector 435 and hence the lengths of the handle supports 410 may be freely adjustable by the user when the handle extension 400 is in use, may not be adjustable except via the use of specialized tools (e.g. if a headless set screw is used as the connector), or may be anywhere in between.

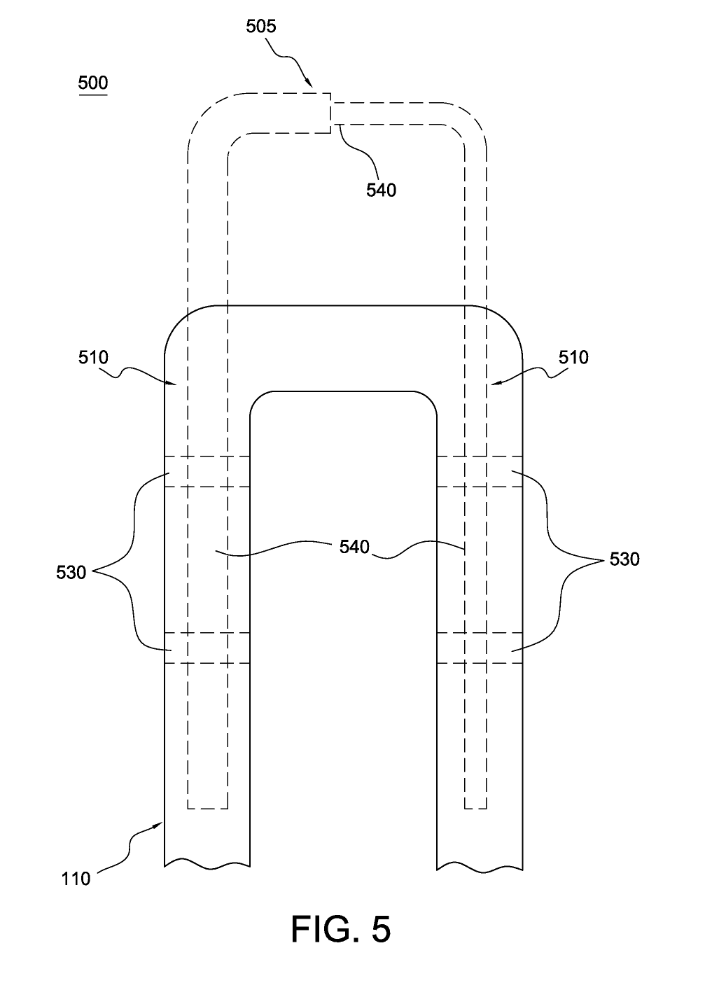

FIG. 5 displays another potential embodiment of a handle extension 500; the configuration displayed may be either a “U” or an “X” configuration as displayed in FIGS. 3 and 4, or may exist as an intermediate between the two. The handle extension 500 is clamped in four places 530 to the handle of a lawn spreader 110 for support; this is sufficient to support the handle extension 500 in this embodiment and no stability bar is necessary. The various component pieces of the push handle 505 and the handle supports 510 have circular cross-sections with varying diameters such that they may freely fit within one another 540, allowing the handle extension to expand or contract both “north-south” and “east-west.”

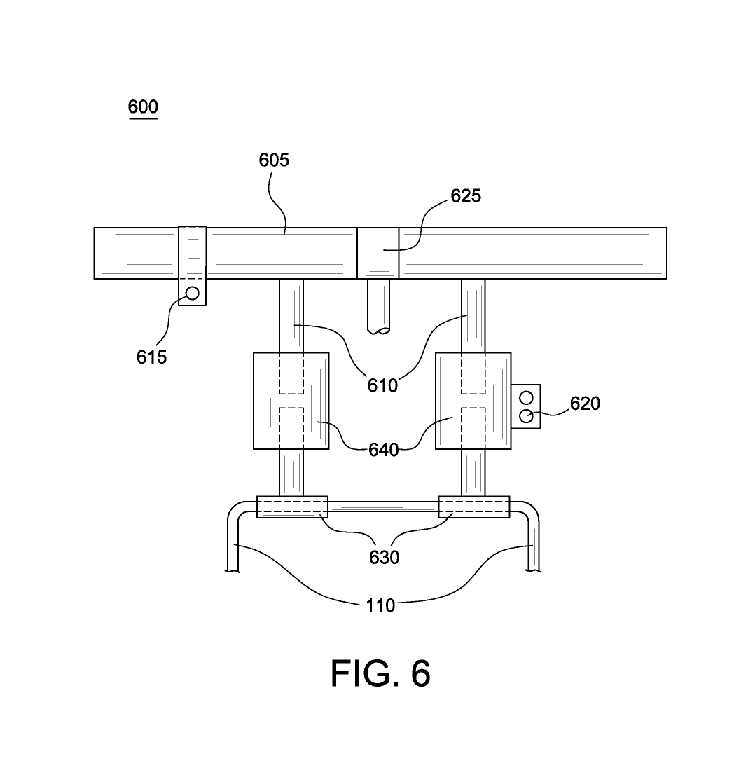

FIG. 6 displays another potential embodiment of a handle extension 600; the handle extension 600 is arranged in an “H” configuration, and has a stability bar 625 and mounting sites 615, 620 for a discharge control device and a settings control device (such as an edge protector) respectively. Such a configuration may attach to the handle of a lawn spreader 110 by clamps or sleeves 630, or may use an alternative connector. Alternatively, more than one of the aforementioned connectors may be used; for example, as in the embodiment shown in FIG. 6, the handle extension 600 may be connected to the handle 110 via clamps 630, but employ adjustable sleeves 640 within the handle supports 610 to enable a user to adjust the height of the handle extension 600. According to one embodiment, the grip portion of the handle of a lawn spreader 110 may be removed, allowing the connecting sleeves 630 to fit over the remaining portions of the handle 110. The connecting sleeves 630 may then be secured to the handle 110 by use of a connector (such as a clamp or wingnut), a friction fit, or any other adjustable or nonadjustable manner (e.g. a magnet, a weld, or an adhesive). According to a second embodiment, clamps may be used instead of connecting sleeves to attach the handle extension 600 to the handle of the lawn spreader 110; the grip portion of the handle of the lawn spreader 110 may be left in place, and the handle extension 600 clamped to the lower or upper side of the handle of the lawn spreader 110 Handle supports 610 may be adjustable or may be of fixed length; if the second is true, “north-south” adjustment of the height of the handle extension 600 may be accomplished by moving the handle extension 600 along the north-south axis such that the clamps, sleeves, or alternative connector 630 aligns with a different portion of the handle of the lawn spreader 110 at a different point. For example, if very little height extension is required, the handle extension 600 may be clamped to a portion of the handle 110 closer to the base.

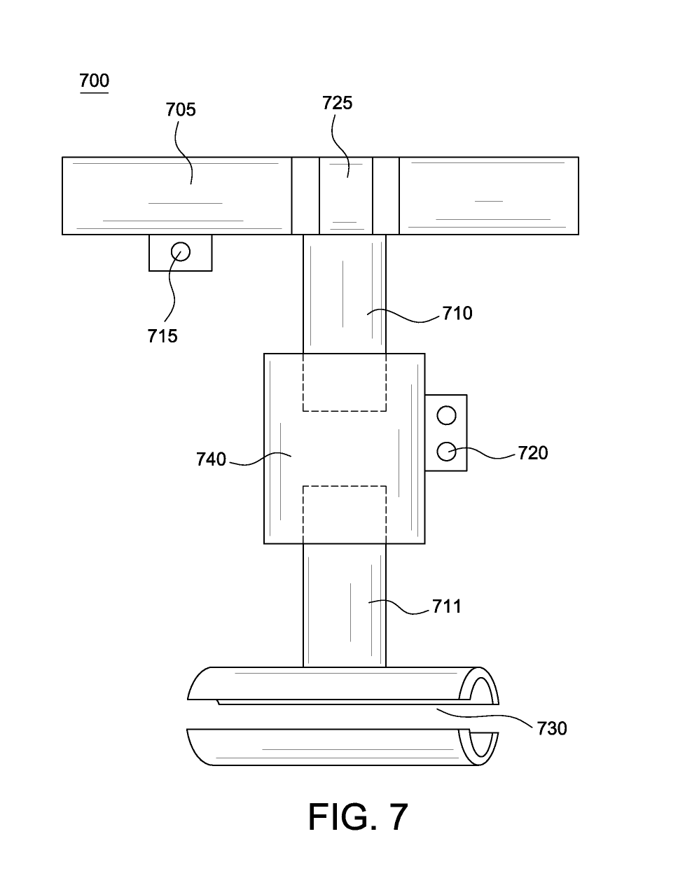

FIG. 7 displays another potential embodiment of a handle extension 700; the handle extension 700 is arranged in a “T” configuration, and has a stability bar 725 and mounting sites 715, 720 for a discharge control device and a settings control device respectively. (The mounting sites 715, 720 may be used for other devices or other purposes, as appropriate; for example, the mounting site for the settings control device 720 may instead be used to support an edge protector for the lawn spreader or a similar device.) A connector 730 may attach the handle extension 700 to a lawn spreader or to the handle of a lawn spreader; this connector 730 may be of any type, including a clamp, bracket, shim, or otherwise. Different connectors 730 may be made available for use with the same handle extension 700, and different connectors 730 may be chosen depending on the specific requirements of the lawn spreader to which the handle extension 700 is to be attached. For example, the handle support portion of the handle extension 700 may be separated into a top half 710 and a bottom half 711, separated by an adjustable sleeve 740; the user may be able to select from among a number of options for use as the bottom half of this support 711 (e.g. some may use a clamp, bracket, shim, etc.), and freely replace them with each other as desired.

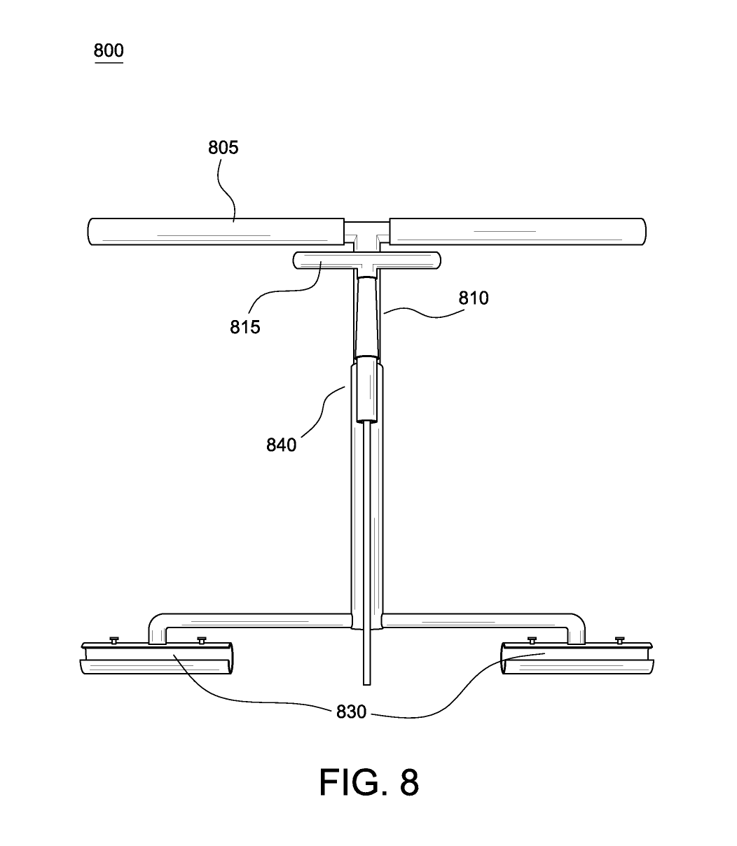

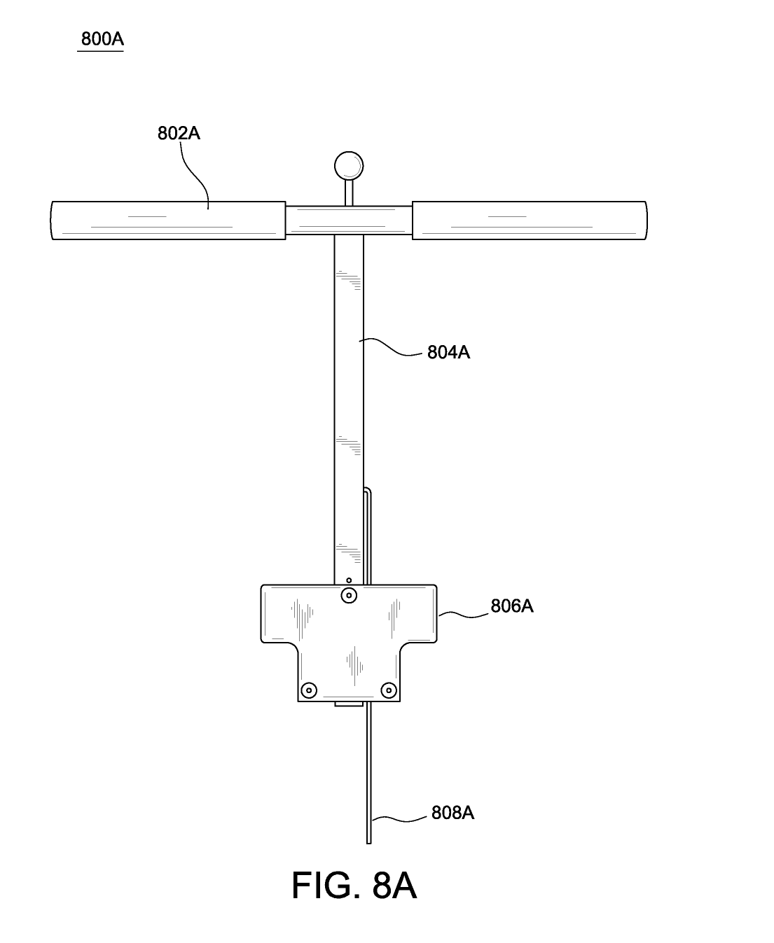

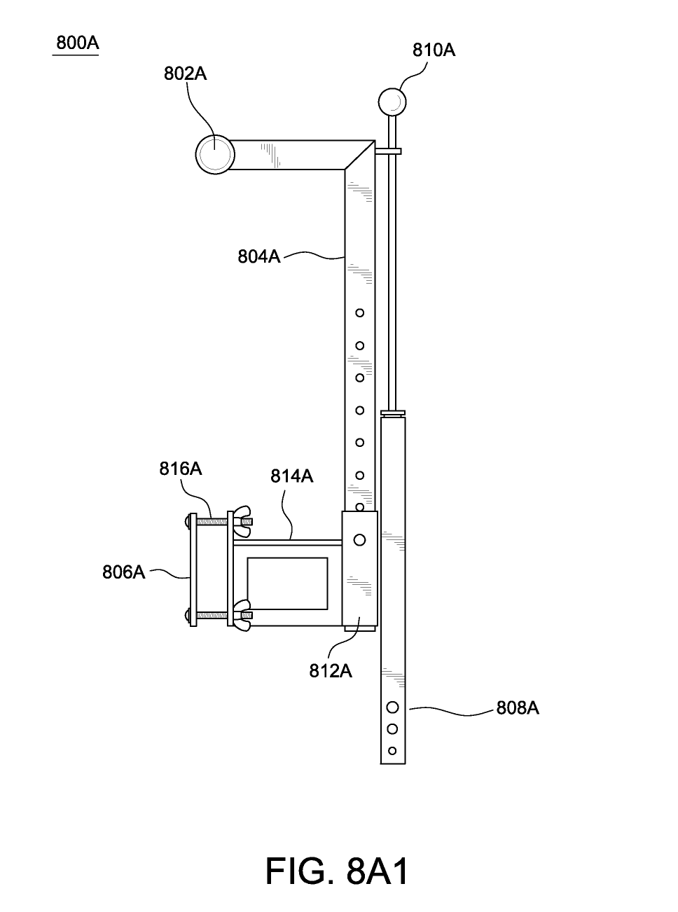

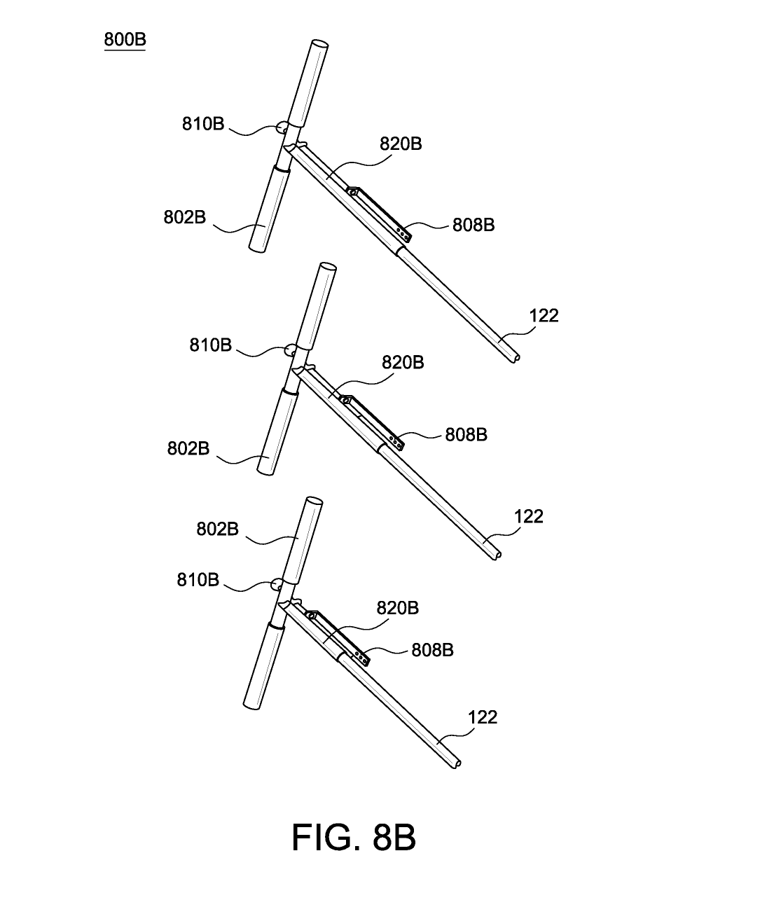

FIG. 8 displays another potential embodiment of a handle extension 800; the handle extension 800 is arranged in a “T” configuration. This embodiment lacks a stability bar and a mounting site for a settings control device. It features a push handle 805 and a handle support 810 that is composed of two overlapping cylindrical parts 840 and which may expand telescopically or otherwise may expand or contract. The embodiment has a plurality of connectors 830 that may be affixed to an appropriate lawn spreader; connectors may be affixed to the body, the handle, or any other part of the lawn spreader, as desired. The central lever 815 may be connected via a cord, cable, rod, or similar part to a discharge control device on a lawn spreader, and may be manipulated forward and/or backward along the “north-south” axis to operate the discharge control device and discharge material from the lawn spreader.

FIGS. 8A and 8A1 display another potential embodiment of a handle extension 800A; the handle extension 800A is arranged in a “T” configuration. This embodiment lacks a stability bar and a mounting site for a settings control device. It features a push handle 802A and a handle support 804A; the handle support may have a round or square cross-section, or one in another shape, as desired. The handle support 804A may be perforated as shown in the side view, FIG. 8A1. The handle support 804A may be integrated with other parts by way of removable connectors or permanent connections; for example, in the embodiment of FIG. 8A, it may be integrated with one or more mounting plates 806A, a riser 814A, and a perforated sleeve 812A. The integration of these parts may allow for the north-south length expansion and contraction of the handle extension 800A. The mounting plate 806A may be connected directly to the existing OEM handle 110 and may be secured by a connector, for example by the mounting screws and wing nuts 816A. Padding, foam or other gripping type material may be installed on one or both mounting plates 806A to aid in the compression. Alternatively, the mounting plate 806A may be secured to the existing OEM handle 110 by tie wraps, other screws or bolts with or without accompanying nuts, or other such connectors. The adjustable push/pull linkage components 808A and 810A may allow for the direct connection to and control of the OEM discharge chute control lever 120 located on the T handle lawn spreader. This connection may be achieved by connecting the southernmost section of the linkage component 808A directly to the control knob 120; alternatively, this component 808A may be connected directly to the OEM discharge chute control linkage 121 (see FIG. 2B) located on the underside of the control lever, effectively bypassing the lever and allowing the adjustable push/pull linkage 808A, 810A to directly manipulate the OEM linkage 121. Alternatively, the OEM discharge lever 120 may be connected via a cord, cable, rod, or similar part to the handle extension 800A. This part may allow a user to manipulate the OEM discharge lever 120 at a distance, enabling a user to operate the discharge control device and discharge material from the lawn spreader as desired.

FIG. 8B displays another potential embodiment of a handle extension 800B; the handle extension 800B is arranged in a “T” configuration. This embodiment lacks a stability bar and a mounting site for a settings control device. The push handle 802B is connected to the OEM handle support 122 (see FIG. 2B) by removing the top portion of the OEM handle 110 and inserting a sleeve apparatus comprising one or more sleeves 820B onto the remaining OEM handle support 122 (see FIG. 2B). A push handle 802B, which may be the OEM handle or may be a different part, may then be inserted into the sleeve apparatus 820B. A sleeve apparatus 820B comprising a plurality of telescoping sleeves or a plurality of adjustably linked sleeves may allow for north-south extension of the connected push handle 802B. The adjustable push/pull linkage components 808B and 810B may be configured to operate the OEM discharge chute if connected to the control knob 120 or if connected directly to the OEM linkage 121 (see FIG. 2B). The OEM discharge lever 120 may be connected via a cord, cable, rod, or similar part to the handle extension 800B, and may be manipulated forward and/or backward along the “north-south” axis to operate the discharge control device and discharge material from the lawn spreader.

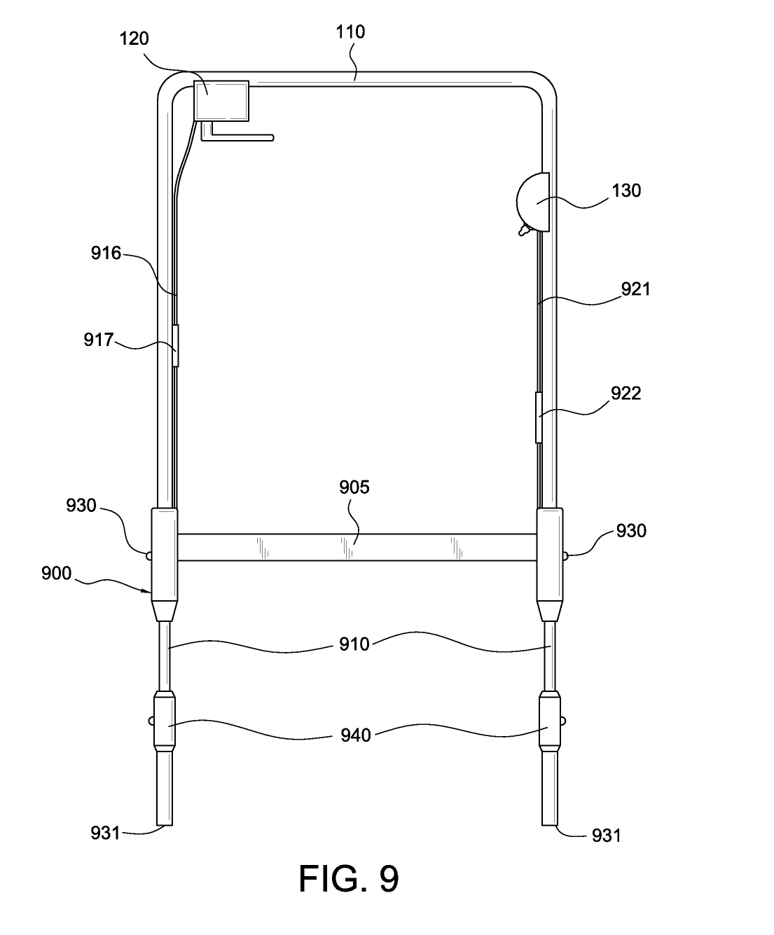

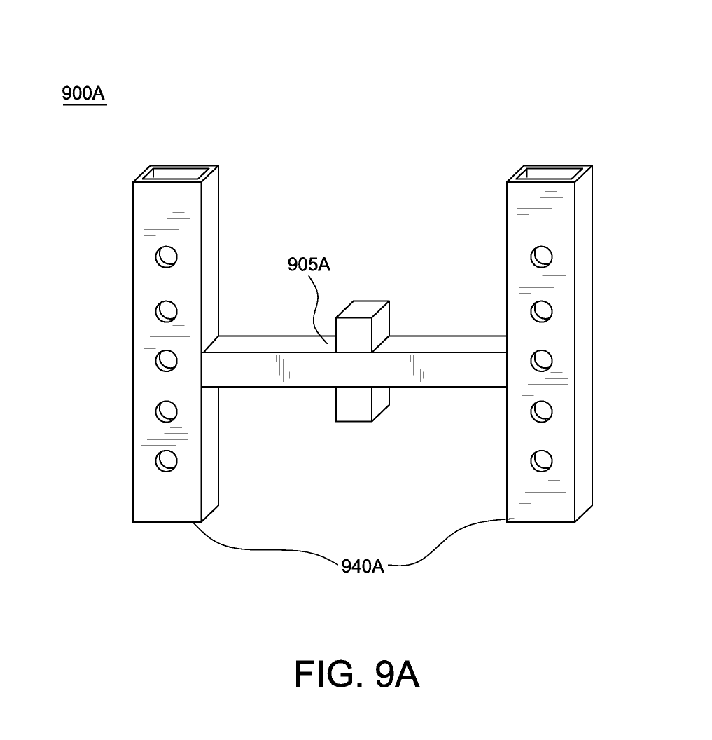

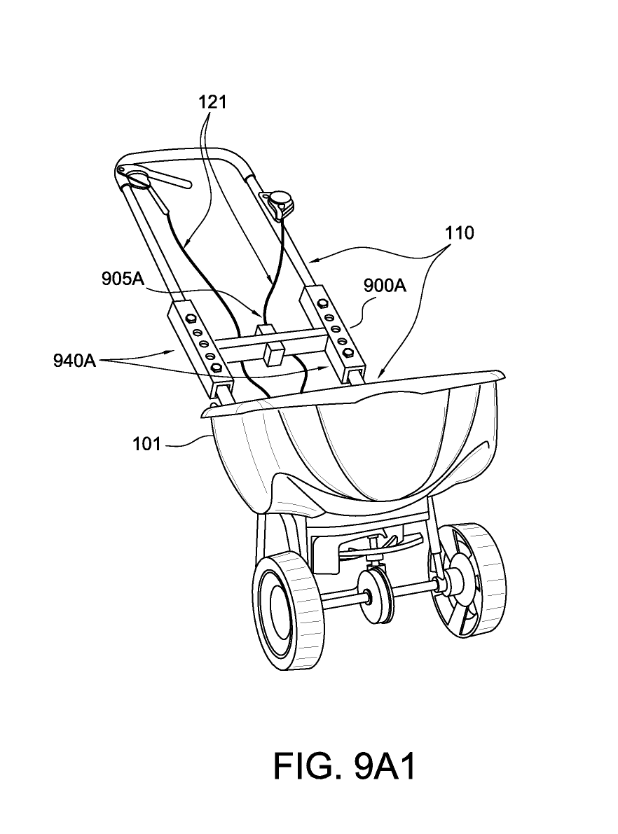

FIG. 9 displays another potential embodiment of a handle extension 900; the handle extension 900 is arranged in an “M” configuration. Unlike other embodiments, an “M” configuration handle extension may fit between the OEM lawn spreader handle 110 and the base of the lawn spreader, and may require that the lawn spreader be partially disassembled in order for the handle extension 900 to be installed. According to an exemplary embodiment, the handle extension may be installed by first removing the OEM lawn spreader handle 110 from the lawn spreader. Next, the handle extension 900 may be attached to the body of the lawn spreader by connectors 931; this may include, for example, c-clamps, wing nuts, or other appropriate mechanical or nonmechanical connectors, and may additionally require that the “southern” portion of the handle extension 900 be adapted to fit inside sockets that the OEM handle 110 was originally mounted inside or otherwise be adapted to mimic the “southern” end of the OEM handle.

As the OEM lawn spreader handle 110 includes a push handle component, it is not required for handle extensions 900 in the “M” configuration to feature a separate push handle. However, the handle extension may include a support structure 905 that bridges the handle supports 910. Likewise, if the OEM lawn spreader handle 110 includes a discharge control device 120 and/or a settings control device 130, these may remain mounted to the OEM lawn spreader handle 110 instead of being moved to mounting sites on the handle extension 900. However, in the event that the discharge control device 120 and/or the settings control device 130 are operationally connected to the body of the lawn spreader with cords or cables 916, 921, it may be necessary to lengthen the discharge control device cord 916 and/or settings control device cord 921 to enable the handle extension 900 to be applied. This may be accomplished by way of splices 917, 922, may be accomplished by swapping in replacement cords or cables, or otherwise lengthened as appropriate.

The handle extension 900 may be extensible; for example, the handle supports 910 may include telescoping portions 940, or may be extended or contracted in length through another appropriate manner. The telescoping portions may be locked in place by set screws, wing nuts, or by another appropriate mechanical or nonmechanical manners of locking The handle extension 900 may also be in the form of individual spacers, telescoping or various fixed lengths and may be independently fitted between the OEM lawn spreader handle 110 and the base of the lawn spreader. Or, alternatively, these spacers may be independently fitted between sections of the existing OEM handle 110.

FIGS. 9A and 9A1 display another potential embodiment of a handle extension 900A, arranged in an “M” configuration. The handle extension 900A may include at least one extensible sleeve 940A and at least one internal support 905A. The handle extension 900A may be inserted between the lawn spreader body 101 and the OEM handle 110 (see FIG. 2A), thereby extending the position of the OEM handle 110 relative to the lawn spreader body 101 and to its original position (see FIG. 9A1). The distance at which the OEM handle 110 is extended may be adjusted by adjusting the length of the at least one extensible sleeve 940A; these sleeves may be secured at a certain length via a set screw or other mechanism. The extensible sleeves 940A may be adjusted, if desired, to a point where they are longer than the OEM cables 121 or other fixed-length features of the original lawn spreader device. These cables or other features may be replaced with longer versions or may be spliced to extend their length; splicing may be accomplished via the use of split bolts or another splicing manner. The extensible sleeves 940A may be telescoping, or may make use of a set screw or other mechanism or apparatus that allows for the north-south expansion and contraction of the handle extension 900A. A stability bar, or other support mechanism, may be provided via a connector, clamp or other mechanism.

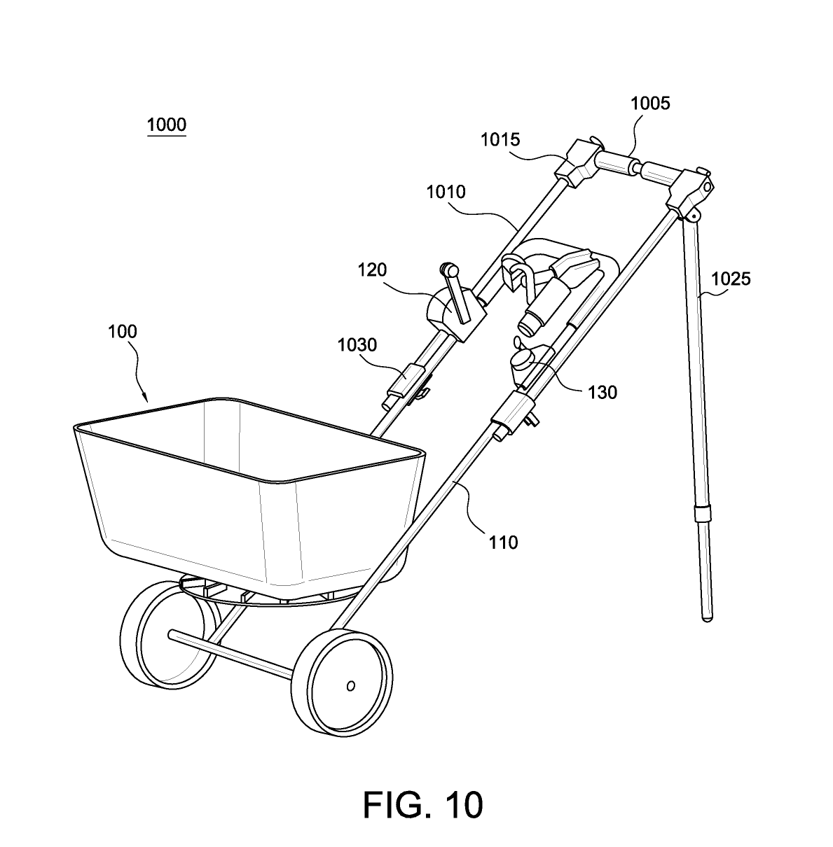

FIG. 10 displays a three-dimensional view of another potential embodiment of a handle extension 1000. The handle extension 1000 is arranged in a “U” configuration, and may feature a push handle 1005, handle supports 1010, and a stability bar 1025. A mounting site for a discharge control device 1015 may be present but unused in this embodiment; according to this embodiment, the discharge control device 120 and the settings control device 130 on the lawn spreader have not been moved or modified. The handle extension 1000 may be secured to the handle of the lawn spreader 110 by connectors such as locking clamps 1030.

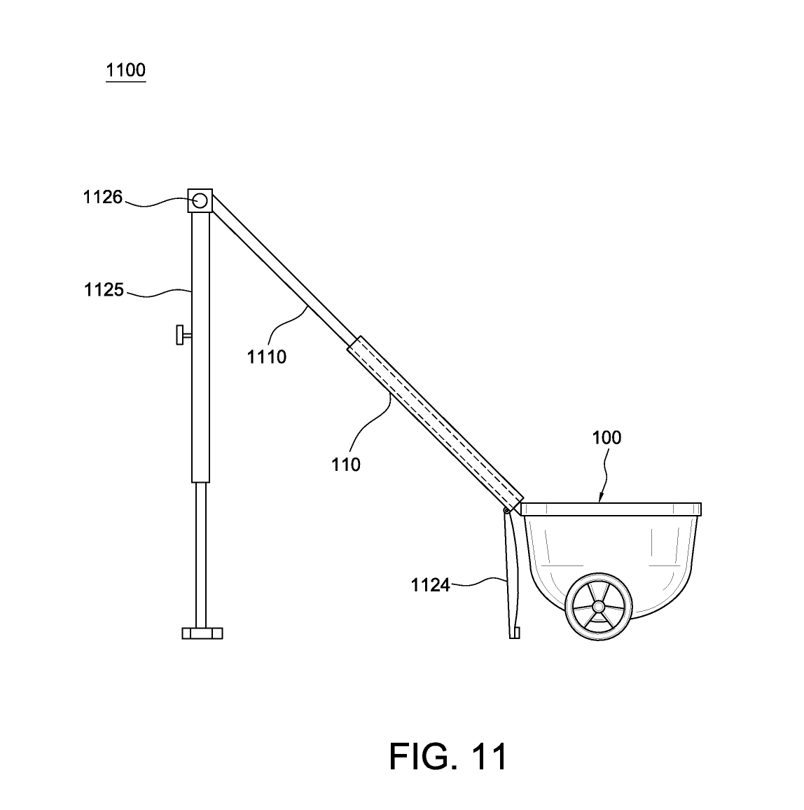

FIG. 11 displays another potential embodiment of a handle extension 1100, as applied to a lawn spreader device 100 that features a stability bar of its own 1124. The handle extension 1100 may still incorporate a supplemental stability bar 1125 despite the presence of a stability bar 1124 on the lawn spreader device 100; the supplemental stability bar 1125 may additionally contribute to device stability and may allow for the use of a handle support 1110 that extends further past the OEM lawn spreader handle 110 without causing the lawn spreader stability bar 1124 to be rendered ineffective. Alternatively, the supplemental stability bar may be removably mounted to the handle support 1110 or to another part of the handle extension 1100, and may be removed when desired.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art (for example, features associated with certain configurations of the invention may instead be associated with any other configurations of the invention, as desired).

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A universal lawn spreader control handle extension attachment, comprising:
at least one external connector;
at least one handle support; and
at least one push handle.

2. The universal lawn spreader control handle extension attachment of claim 1, wherein the at least one push handle is capable of east-to-west expansion and contraction.

3. The universal lawn spreader control handle extension attachment of claim 1, wherein the at least one handle support is capable of north-to-south expansion and contraction.

4. The universal lawn spreader control handle extension attachment of claim 1, wherein the at least one push handle is capable of expansion and contraction in length and is capable of being securely fastened in place at a user's desired length.

5. The universal lawn spreader control handle extension attachment of claim 1, wherein the at least one handle support is capable of expansion and contraction in length and is capable of being securely fastened in place at a user's desired length.

6. The universal lawn spreader control handle extension attachment of claim 1, wherein the universal lawn spreader control handle extension attachment additionally includes at least one stability bar.

7. The universal lawn spreader control handle extension attachment of claim 6, wherein the at least one stability bar is capable of expansion and contraction in length and is capable of being securely fastened in place at a user's desired length.

8. The universal lawn spreader control handle extension attachment of claim 1, wherein the universal lawn spreader control handle extension attachment additionally includes at least one control device that is capable of being operationally linked to a lawn spreader device.

9. The universal lawn spreader control handle extension attachment of claim 8, wherein the at least one control device is capable of being operationally linked to an original-equipment-manufacturer-supplied (OEM) control located on a lawn spreader device without requiring modification of an OEM control or of the lawn spreader device.

10. The universal lawn spreader control handle extension attachment of claim 8, wherein the at least one control device is capable of being operationally linked to an OEM control on a lawn spreader device if an OEM control cable is replaced.

11. The universal lawn spreader control handle extension attachment of claim 8, wherein the at least one control device is capable of being operationally linked to an OEM control on a lawn spreader device if an OEM control cable is spliced with accessory hardware.

12. The universal lawn spreader control handle extension attachment of claim 1, wherein the universal lawn spreader control handle extension attachment is configured in a “U” configuration, comprising a plurality of parallel handle supports linked by a push handle aligned substantially perpendicular to the plurality of parallel handle supports.

13. The universal lawn spreader control handle extension attachment of claim 1, wherein the universal lawn spreader control handle extension attachment is configured in a “T” configuration, comprising a handle support terminating in a push handle aligned substantially perpendicular to the handle support and extending from more than one point near the terminal part of the handle support.

14. The universal lawn spreader control handle extension attachment of claim 1, wherein the universal lawn spreader control handle extension attachment is configured in a “X” configuration, comprising a plurality of parallel handle supports linked by a push handle aligned substantially perpendicular to the plurality of parallel handle supports, and further comprising a portion that may be connected to the body of a lawn spreader device when the universal lawn spreader control handle extension attachment is in use.

15. The universal lawn spreader control handle extension attachment of claim 1, wherein the universal lawn spreader control handle extension attachment is configured in a “H” configuration, comprising a handle support terminating in a push handle aligned substantially perpendicular to the handle support and extending from more than one point near the terminal part of the handle support, and further comprising a plurality of connectors located on the “southern” portion of the universal lawn spreader control handle extension attachment according to the “north-south” terminology used herein.

16. A universal lawn spreader control handle extension attachment in the “M” configuration, comprising:
at least one external connector adapted to connect to an OEM lawn spreader handle;
at least one external connector adapted to connect to a lawn spreader body; and
at least one handle support.

17. A universal lawn spreader control handle, comprising:
at least one external connector;
at least one extension mechanism;
at least one handle support; and
at least one push handle.

18. The universal lawn spreader control handle of claim 17, wherein the universal lawn spreader control handle additionally includes at least one control device that is capable of being operationally linked to a lawn spreader device.

19. The universal lawn spreader control handle of claim 18, wherein the at least one control device is capable of being operationally linked to an OEM control on a lawn spreader device if an OEM control cable is replaced.

20. The universal lawn spreader control handle of claim 18, wherein the at least one control device is capable of being operationally linked to an OEM control on a lawn spreader device if an OEM control cable is spliced with accessory hardware.
